(19) United States
(12) Patent Application Publication
(10) Pub. No.: US 2012/0156377 A1
(43) Pub. Date: Jun. 21, 2012

(54) AGENT FOR TREATING HARD SURFACES

(75) Inventors: Birgit Veith, Dusseldorf (DE); Mirko Weide, Dusseldorf (DE); Nadine Warkotsch, Munchen (DE); Brigitte Giesen, Dusseldorf (DE); Stefan Stumpe, Dusseldorf (DE); Roland Breves, Mettmann (DE)

(73) Assignee: Henkel AG & Co. KGaA, Dusseldorf (DE)

(21) Appl. No.: 13/409,354

(22) Filed: Mar. 1, 2012

Related U.S. Application Data
(63) Continuation of application No. PCT/EP2010/062108, filed on Aug. 19, 2010.

(30) Foreign Application Priority Data
Sep. 1, 2009 (DE) 10 2009 029 060.5

(51) Int. Cl. C09K 3/00; B05D 3/00; B08B 3/08; C03C 17/32; B05D 7/14; B05D 7/02; C11D 3/60; B05D 7/00

(52) U.S. Cl. 427/331; 510/475; 510/476; 106/2; 134/26; 134/28

(57) ABSTRACT

The present invention is an agent for treating a hard surface comprising at least two components selected from the group consisting of (a) multi-armed stellate polyalkoxylates; (b) polyesteramides; and (c) copolymers prepared from a quaternary ammonium acrylamide and acrylic acid. The agents of the present invention find use in cleaning hard surfaces and/or providing a soil-repellant finish to hard surfaces such as ceramic, glass, stainless steel and plastic.

### CROSS-REFERENCE TO RELATED APPLICATIONS

This application is a continuation of PCT Application Serial No. PCT/EP2010/062108, filed on Aug. 19, 2010, which claims priority under 35 U.S.C. §119 to 10 2009 029 060.5 (DE) filed on Sep. 1, 2009. The disclosures PCT/EP2010/062108 and DE 10 2009 029 060.5 are hereby incorporated by reference in their entirety.

### FIELD OF THE INVENTION

The present invention generally relates to agents used in treating a hard surface, and more particularly relates to agents used for cleaning and/or providing a dirt-repellent finish on hard surfaces.

### BACKGROUND OF THE INVENTION

In both the household and commercial fields, there are many different types of hard surfaces which are exposed to the effects of the most varied kinds of dirt. The surfaces of wall and floor tiles, glazing, kitchen appliances and ceramic sanitary ware may be mentioned purely by way of example. Agents containing surfactants have long been used for cleaning such surfaces, the cleaning action of which agents is primarily determined by the ability of surfactants to solubilize dirt particles, so making it possible to detach them or rinse them off from the surface. However, depending on the nature of the surface and nature of the dirt, the dirt can adhere remarkably strongly to the surface. This is all the more the case if the soiling remains for an extended period of time on the surface and the adhesion is so further strengthened by ageing processes. As a result, the dirt may become very difficult to remove and thus cause major difficulty with cleaning. The search has therefore intensified in recent times for agents which not only improve the cleaning power of cleaning agents but which prevent or at least delay the soiling of surfaces which are already in use.

Methods have accordingly been developed for various hard materials by means of which these materials may be provided with a dirt-repellent finish during their production. However, such permanent finishes can only be produced by complicated methods and are generally only available for new materials which are finished in this way by the original manufacturer.

In addition, however, agents have also been found with which surfaces may subsequently be provided with a finish in a manner which can be carried out domestically such that, at least for a certain service life, they are less easily soiled or may be cleaned more easily (also known as a “semi-permanent finish”).

Facilitating and improving cleaning and preventing renewed soiling are of particular practical interest in the area of ceramic sanitary ware. Cleaning flush toilets above all involves removing lime and urine scale and fecal residues adhering to the ceramics. Conventional toilet cleaning agents are frequently made acidic, for example by addition of organic acids such as citric acid or sulfamic acid, to ensure a high level of effectiveness against lime and urine scale. Cleaning performance against fecal soiling is generally also good, but mechanical force must be applied, thus with the assistance of a toilet brush, to the surface of the toilet. This mechanical effort is greater in the case of older, already dried on soiling, with even moist fecal soiling being capable of adhering tenaciously to ceramic materials.

Patent application WO 2006/005358 discloses copolymers which consist of at least one of each of an anionic vinyl monomer, a vinyl monomer with a quaternary ammonium group or a tertiary amino group, and a nonionic hydrophilic vinyl monomer or a polyfunctional vinyl monomer. These copolymers are suitable as soil-inhibiting components in cleaning agents and are effective, for example, against fecal soiling.

However, even using these cleaners, longer lasting cleanness, which extends beyond one-off use, of the toilet interior relative to renewed fecal soiling cannot be achieved in completely satisfactory manner.

A further problem may also arise from the fact that, to enhance dissolution of lime, toilet cleaning agents are not uncommonly left to act on the ceramics for an extended period of time, often for several hours or even overnight. In order to promote adhesion to the ceramics, the formulations are generally thickened. In the event of an extended period of action, a film then forms on the surface which, due to the product color, is usually colored and, once having dried on, can only be removed with difficulty.

Hard surfaces which are repeatedly exposed to the action of moisture are frequently colonized by microorganisms, resulting in the formation of biofilms. Biofilms consist of a mucilaginous layer (film) in which microorganisms (for example bacteria, algae, fungi, protozoa) are embedded. This may constitute a problem of not only a hygienic but also an esthetic nature. Biocidal substances are frequently used as countermeasures. However, this is not always without its own problems due to the ecotoxicological properties of many of these substances and the associated restrictions on their use. Moreover, biofilms contribute to the formation of unpleasant smelling substances and are therefore a source of unwanted malodors, in particular in sanitary applications.

Agents for treating hard surfaces must furthermore satisfy other requirements. For instance, it is important for the appearance of the surface not to be impaired after it has been treated. Factors which are in particular of importance here are the retention of gloss on surfaces which in the original or clean state are glossy and the avoidance of residues of the treatment agent, for example in the form of lines or streaks.

PCT Application Publications WO 2008/068236 and WO 2008/068235 disclose the use of multi-armed silyl polyalkoxylates for providing a finish on surfaces. Also, PCT Application Publication WO 2009/071452 discloses that polyesteramides may be used to provide a finish on surfaces.

There is a need for methods and agents for providing a dirt-repellent finish on a hard surface and/or for facilitating the detachment of dirt and/or for reducing the formation or adhesion of biofilms, it being possible to achieve these effects either in an independent surface treatment method or alternatively in the course of a cleaning method in which a surface is cleaned and simultaneously provided with the above-stated properties.

In producing such agents, it is furthermore necessary for the ingredients used to be straightforwardly incorporable into the formulation and for the agents to exhibit good storage stability.

Accordingly, it is desirable to remedy at least in part the above-stated disadvantages of the prior art. In particular, there is a continued need for agents capable of improving the removability of dirt and biofilms from hard surfaces, in particular toilet ceramics, and to prevent such soiling from reforming on such surfaces. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

It has now been surprisingly found that a mixture of at least two components selected from the group consisting of (a) a multi-armed stellate polyalkoxylate; (b) a polyesteramide; and (c) a copolymer prepared from a quaternary ammonium acrylamide and acrylic acid, exhibit distinctly improved properties relative to the individual components.

In an exemplary embodiment of the present invention, an agent is described for treating a hard surface, in particular for cleaning and/or for providing a dirt-repellent finish on a hard surface and/or for reducing the adhesion of microorganisms to a hard surface, where said agent comprises at least two components selected from the group consisting of: (a) a multi-armed stellate polyalkoxylate; (b) a polyesteramide; and (c) a copolymer prepared from a quaternary ammonium acrylamide and acrylic acid.

In a preferred exemplary embodiment of the present invention, the agent for treating hard surfaces comprises a mixture of a multi-armed silyl polyalkoxylate and a polyesteramide.

In another preferred exemplary embodiment, a mixture of a multi-armed silyl polyalkoxylate and a copolymer prepared from a quaternary ammonium acrylamide and acrylic acid is used.

In yet another preferred exemplary embodiment, a mixture of a polyesteramide and a copolymer prepared from a quaternary ammonium acrylamide and acrylic acid is used.

In yet another preferred exemplary embodiment, a mixture of a multi-armed silyl polyalkoxylate, a polyesteramide and a copolymer prepared from a quaternary ammonium acrylamide and acrylic acid is used.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

With that being said, the present invention is an agent is for treating a hard surface, in particular for cleaning and/or for providing a dirt-repellent finish on a hard surface and/or for reducing the adhesion of microorganisms to a hard surface, comprising at least two components selected from the group consisting of: (a) a multi-armed stellate polyalkoxylate; (b) a polyesteramide; and (c) a copolymer prepared from a quaternary ammonium acrylamide and acrylic acid.

Multi-Armed Stellate Polyalkoxylates

Multi-armed stellate polyalkoxylates for the purposes of the present invention contain polymer arms which are attached in substantially stellate or radial manner to a central unit and in each case comprise polyoxyalkylene units, preferably polyoxyethylene units and/or polyoxypropylene units. The number of polymer arms preferably amounts to 3 to 20, in particular to 3 to 8. The mass-average (weight-average) molecular weight preferably amounts to 500 to 100,000, in particular to 1,000 to 50,000, and particularly preferably to 2,000 to 30,000. Functional groups, such as for instance positively or negatively charged groups or reactive groups may optionally be located peripherally on the polymer arms. Multi-armed stellate polyalkoxylates which may be used according to the invention are described for example in patents WO 2003/063926, WO 2007/096056 and DE102008063070.

In an embodiment which is preferred according to the invention, the multi-armed stellate polyalkoxylate is a silyl polyalkoxylate or a mixture of a plurality of these compounds, in which the silyl group is preferably located peripherally on the polymer arms. The silyl polyalkoxylate here preferably contains 0.3 to 10 wt. %, particularly preferably 0.5 to 5 wt. % of silicon, relative to the total weight of the silyl polyalkoxylate. Alkoxy and alkyl groups are preferably attached to the peripheral silyl groups themselves; instead or in addition, further functional groups may in turn be attached to the silyl groups.

The multi-armed silyl polyalkoxylate preferably comprises a compound of the formula (I):

(H-D)ₚ-Z-[D-E-Si(OR¹)ᵣ(R²)₃₋ᵣ]ₒ (I)

wherein Z denotes an (o+p)-valent residue with at least three carbon atoms; D denotes a divalent polyoxyalkylene residue in which the o+p polyoxyalkylene residues attached to Z may differ from one another and one residue D is in each case joined to Z via an oxygen atom belonging to Z and an oxygen atom belonging to D is joined to E or hydrogen; E denotes a chemical bond or a divalent organic residue with 1 to 50 carbon atoms; OR¹ denotes a hydrolyzable group; R¹ and R² mutually independently denote a linear or branched alkyl group with 1 to 6 carbon atoms; r denotes an integer from 1 to 3; denotes 0 or an integer ≧1; and p denotes 0 or an integer ≧1, and o+p has a value of 3 to 100.

In formula (I), Z preferably denotes an at least trivalent, in particular tri- to octavalent, acyclic or cyclic hydrocarbon residue with 3 to 12 carbon atoms, in which the residue may be saturated or unsaturated and in particular also aromatic. Z particularly preferably denotes the trivalent residue of glycerol or the tri- to octavalent residue of a sugar, for example the hexavalent residue of sorbitol or the octavalent residue of sucrose. The x-valent residue of one of the above-stated polyols should here be taken to mean the molecular fragment of the polyol which remains after removal of the hydrogen atoms from x alcoholic or phenolic hydroxyl groups. Z may in principle denote any central unit which is known from the literature for producing stellate (pre)polymers.

It is furthermore particularly preferred in the formula (I) for p to denote 0, 1 or 2 and for o to mean a number from 3 to 8.

In formula (I), D preferably denotes groups selected from poly-C₂-C₄-alkylene oxides, particularly preferably a (co)polymer of ethylene oxide and/or propylene oxide, in particular a copolymer with a proportion of propylene oxide of up to 60 wt. %, preferably of up to 30 wt. % and particularly preferably of up to 20 wt. %, in which the polymers may be random and/or block copolymers. Accordingly, in a further preferred embodiment of the invention, D in the formula (I) denotes —(CHR³—CHR⁴—O)_{q}—, in which R³ and R⁴ mutually independently mean hydrogen, methyl or ethyl and q means an integer from 2 to 10,000.

In formula (I), E in particular denotes a chemical bond or a divalent, low molecular weight organic residue with preferably 1 to 50, in particular 2 to 20 carbon atoms. Examples of divalent low molecular weight organic residues are short-chain aliphatic and heteroaliphatic residues such as for example —(CH₂)₂—, —(CH₂)₃—, —C(O)—NH—(CH₂)₃-und —C(O)—NH—X—NH—C(O)—NH—(CH₂)₃—, in which X denotes a divalent aromatic residue such as the phenylene residue or denotes an alkylidene residue. E very particularly preferably denotes a bond or the residue —C(O)—NH—(CH₂)₃—.

Preferably, R¹ and R² mutually independently denote methyl or ethyl, and R denotes 2 or 3. Examples of residues —Si(OR¹)ᵣ(R²)₃, are dimethylethoxysilyl, dimethylmethoxysilyl, diisopropylethoxysilyl, methyl dimethoxysilyl, methyldiethoxysilyl, trimethoxysilyl, triethoxysilyl or tri-t-butoxysilyl residues, but trimethoxysilyl and triethoxysilyl residues are very particularly preferred.

It is very particularly preferred for R¹ and R² to be identical and to denote methyl or ethyl.

It is furthermore particularly preferred for r to denote the number 3.

The total of o+p preferably amounts to 3 to 50, in particular 3 to 10 and particularly preferably 3 to 8, and matches the number of arms which are attached to the central unit Z in the compound (I). The central unit therefore preferably has 3 to 50, in particular 3 to 10 and particularly preferably 3 to 8 oxygen atoms which serve as connection points for the arms.

In one particular embodiment, o is equal to 0. In the event that n is >0, the ratio o:p is between 99:1 and 1:99, preferably 49:1 and 1:49, and in particular 9:1 and 1:9.

In a further preferred embodiment of the invention, the agent contains a mixture of at least two, in particular two to four different multi-armed silyl polyalkoxylates of the formula (I).

It is particularly preferred here for the at least two different multi-armed silyl polyalkoxylates to differ in their number of arms. A first silyl polyalkoxylate with 3 to 6 arms is here advantageously combined with a second silyl polyalkoxylate with 6 to 10 arms.

Particularly preferred mixtures are those comprising at least two different multi-armed silyl polyalkoxylates of the formula (I) with p=0, which are selected from the group of multi-armed silyl polyalkoxylates of the formula (I) with o=3, o=6 and o=8.

If two different multi-armed silyl polyalkoxylates are used, they are generally present in a quantity ratio of 99:1 to 1:99, preferably of 49:1 to 1:49, and in particular of 9:1 to 1:9.

With regard to the production of silyl polyalkoxylates usable according to the invention, reference is in particular also made to published patent applications WO 2008/068236 and WO 2008/068235. Suitable polyalkoxylate precursors for producing silyl polyalkoxylates usable according to the invention are obtainable for example under the trade names Voranol 4053, Wanol R420 or Voranol CP 1421. Voranol 4053 is a polyether polyol (poly(ethylene oxide-co-propylene oxide)) from DOW Chemicals. This is a mixture of two different polyether polyols, consisting of a tri-armed polyether polyol with glycerol as central unit and an octa-armed polyether polyol with cane sugar as central unit. The arms are random copolymers of approx. 75% EO and approx. 25% PO, the OH functionality (hydroxyl end groups) amounts on average to 6.9 at a mass-average (weight-average) molecular weight of approx. 12,000. This results in a ratio of approx. 78% octa-armed polyether polyol and approx. 22% tri-armed polyether polyol. Another example is Wanol R420 from WANHUA, China, which is a mixture of a linear poly(propylene/ethylene)diethylene glycol and an octa-armed polyether polyol (poly(propyleneoxy/ethyleneoxy)sucrose) in a ratio of approx. 15-25:85-75. Another commercially obtainable polyether polyol is Voranol CP 1421 from DOW Chemicals, which comprises a tri-armed random poly(ethylene oxide-co-propylene oxide) with an EO:PO ratio of approx. 75:25 and a mass-average (weight-average) molecular weight of approx. 5000.

The silyl polyalkoxylates usable according to the invention are obtainable from these polyalkoxylate precursors by reacting the hydroxyl end groups of these multi-armed polyalkoxylate precursors with functional silanes which comprise a functional group which is reactive towards the hydroxyl end groups of the polyalkoxylate precursors. Examples are tetraalkoxysilanes such as tetramethyl silicate and tetraethyl silicate, (meth)acrylate silanes such as (3-methacryloxypropyl)trimethoxysilane, (methacryloxymethyl)triethoxysilane, (methacryloxymethyl)methyldimethoxysilane and (3-acryloxypropyl)trimethoxysilane, isocyanatosilanes such as (3-isocyanatopropyl)trimethoxysilane, (3-isocyanatopropyl)triethoxysilane, (isocyanatomethyl)methyldimethoxysilane and (isocyanatomethyl)trimethoxysilane, aldehyde silanes such as triethoxysilylundecanal and triethoxysilylbutyraldehyde, epoxy silanes such as (3-glycidoxypropyl)-trimethoxysilane, anhydride silanes such as 3-(triethoxysilyepropylsuccinic anhydride, halosilanes such as chloromethyltrimethoxy-silane and 3-chloropropylmethyldimethoxysilane, hydroxysilanes such as hydroxymethyltriethoxysilane and tetraethyl silicate (TEOS), which are commercially obtainable for example from Wacker Chemie GmbH (Burghausen), Gelest, Inc. (Morrisville, USA) or ABCR GmbH & Co. KG (Karlsruhe) or may be produced using known methods. Silyl polyalkoxylates usable according to the invention are particularly preferably produced using tetraalkoxysilanes, isocyanatosilanes or anhydride silanes, but in particular isocyanatosilanes or anhydride silanes.

The multi-armed, stellate polyalkoxylate, and in particular the silyl polyalkoxylate, is used in the agents according to the invention preferably in a quantity of 0.001 to 5 wt. %, in particular of 0.005 to 2 wt. %, particularly preferably of 0.02 to 0.5 wt. % and above all of 0.05 to 0.3 wt. %, in each case relative to the total weight of the agent.

Polyesteramides

The polyesteramides to be used according to the invention preferably contain at least two groups according to the formula (II):

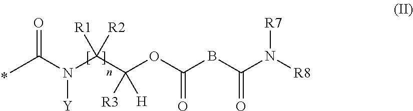

and/or at least two groups according to formula (III):

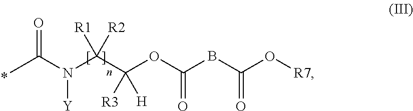

wherein Y denotes H, C₁₋₂₀ alkyl, C₆₋₁₀ aryl,

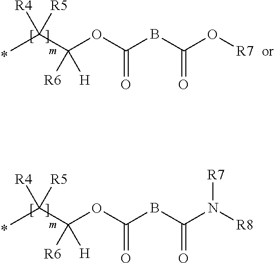

wherein B denotes C₂₋₂₄ alkylene or C₆₋₂₄ arylene; R1, R2, R3, R4, R5 and R6 mutually independently denote H, C₁₋₈ alkyl or C₆₋₁₀ aryl; R7 and R8 mutually independently denote C₁₋₂₈ alkyl or C₆₋₁₀ aryl optionally substituted by heteroatoms; and m and n mutually independently assume a value from 1 to 4, in which the value of m and n preferably amounts to 1.

The polyesteramide here particularly preferably comprises a polymer according to formula (IV):

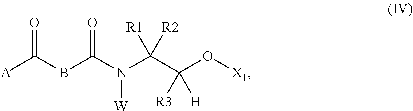

wherein W denotes H, C₁₋₂₀ alkyl, C₆₋₁₀ aryl or

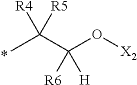

A denotes OH or

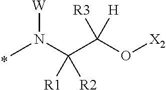

B denotes C₂₋₂₄ alkylene or C₆₋₂₄ arylene; X₁ denotes

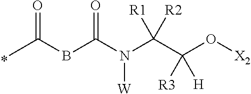

X₂ denotes H, X₁

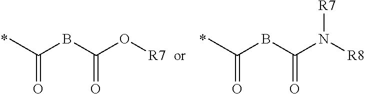

R1, R2, R3, R4, R5 and R6 mutually independently denote H, C₁₋₈ alkyl, C₆₋₁₀ aryl or —CH₂—OX₂; and R7 and R8 mutually independently denote C₁₋₂₈ alkyl or C₆₋₁₀ aryl optionally substituted by heteroatoms or by groups containing heteroatoms.

In a very particularly preferred embodiment, the polyesteramide is a polymer according to formula (V):

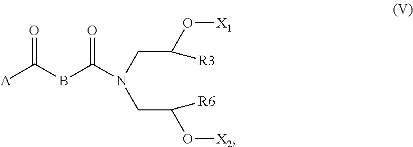

wherein A denotes OH or

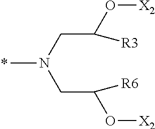

B denotes C₂₋₂₄ alkylene or C₆₋₂₄ arylene; X₁ denotes

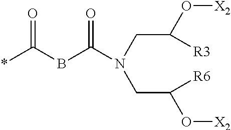

X₂ denotes hydrogen, X₁

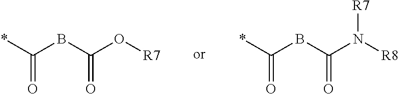

R3 and R6 mutually independently denote H, C₁₋₈ alkyl or C₆₋₁₀ aryl; and R7 and R8 mutually independently denote C₁₋₂₈ alkyl or C₆₋₁₀ aryl optionally substituted by heteroatoms or by groups containing heteroatoms.

In all the above-stated embodiments, R3 and R6 preferably denote C₁₋₄ alkyl, particularly preferably methyl or ethyl. Moreover in all the above-stated embodiments R7 and R8 preferably denote C₁₋₂₀ alkyl optionally substituted by heteroatoms and/or by groups containing heteroatoms, particularly preferably C₂, C₃ or C₆ alkyl substituted by heteroatoms and/or by groups containing heteroatoms.

R7 and R8 may in particular be mono- or polysubstituted by groups selected from alcohols, ethers, polyethers, esters, cyanide, carbonate, urethane, urea, amide, imide, amine, imine, imidazole, oxime, sulfide, thiol, thiourea, sulfone, sulfone oxide, sulfate, phosphate, phosphine, phosphine oxide, silane, silicone, silicate, fluorine, chlorine, bromine or iodine and from groups which contain at least one of the above-stated functional groups.

Examples of residues R7 and R8 according to the invention include di(m)ethylaminoethyl, di(m)ethylaminopropyl and di(m)ethylaminohexyl and quaternized forms of these residues; tri(m)ethylsilylpropyl, tri(m)ethoxysilylpropyl, perfluoroctyl, perfluoroctyl(m)ethyl, (m)ethoxyethyl, (m)ethoxy-2-propyl, maleimidopropyl, maleimidohexyl, octenylsuccinimidohexyl, hexahydrophthalimidohexyl, 2-(benzo)imidazolethyl, diphenylphosphinoethyl, furfuryl, cyanoethyl, cyanopropyl and optionally substituted morpholine, thiomorpholinyl, piperidine, pyrrolidine, oxazolidine, thiazolidine or piperazine.

In one embodiment which is particularly preferred according to the invention, the residues R7 and R8 mutually independently contain quaternized amino groups or polyether groups, in particular polyoxyethylene groups, or any desired mixtures thereof, in which in the same molecule some residues R7 and R8 may contain only quaternized amino groups and other residues R7 and R8 only polyether groups, in particular polyoxyethylene groups. The polyoxyethylene groups here preferably contain 3 to 20, particularly preferably 5 to 15, in particular 6 to 10 oxyethylene units, in which the hydroxyl end group of the oxyethylene units may be etherified with a short-chain alcohol, in particular methanol.

In one very particularly preferred embodiment, at least 10%, preferably at least 20% or 30%, of the residues R7 and R8 are tri(m)ethylammonium alkyl residues, in particular selected from tri(m)ethylammonium ethyl, tri(m)ethylammonium propyl and tri(m)ethylammonium hexyl.

In another very particularly preferred embodiment, at least 10%, preferably at least 20% or 30%, of the residues R7 and R8 are polyoxyethylene groups with 6 to 10, preferably with 7, 8 or 9, oxyethylene units, which may optionally be terminally etherified with methyl or ethyl.

In all the above-stated embodiments, B may optionally be substituted, preferably by a C₁₋₂₆ alkyl residue, particularly preferably by methyl, octenyl, nonenyl, decenyl, undecenyl or dodecenyl. B may here in particular be a residue optionally substituted by one of the above-stated residues selected from ethylene, ethenylene, 1,3-propylene, 1,2-cyclohexyl, 1,2-phenylene, 1,3-phenylene, 1,4-phenylene, 2,3-norbornyl, 2,3-norbornen-5-yl and 1,2-cyclohex-4-enyl.

The molecular weight of the polyesteramides according to the invention preferably amounts to from 600 g/mol to 50,000 g/mol, particularly preferably from 1,000 g/mol to 40,000 g/mol, above all from 5,000 g/mol to 35,000 g/mol. The polyesteramide according to the invention may be both linear and branched, but is preferably a branched polymer, particularly preferably a highly branched polymer.

With regard to polyesteramides which are usable according to the invention and in particular with regard to the production thereof, reference is in particular also made to the disclosure content of WO 99/16810 and WO 00/58388. Polyesteramides which are usable according to the invention are for example obtainable under the trade names Hybrane DAEO 5000 28037 or Hybrane Quat 48 from DSM.

The polyesteramides are present in the agents according to the invention preferably in a quantity of 0.02 to 5.0 wt. %, particularly preferably in a quantity of 0.05 to 2.0 wt. %, in particular in a quantity of 0.1 to 1.0 wt. %, above all in a quantity of 0.1 to 0.8 wt. %.

Copolymers Prepared from a Quaternary Ammonium Acrylamide and Acrylic Acid

The copolymers prepared from a quaternary ammonium acrylamide and acrylic acid are preferably copolymers prepared from diallyldimethylammonium acrylamide and acrylic acid. Such copolymers are for example obtainable under the trade name Mirapol Surf from Rhodia. Mirapol Surf-S100, Mirapol Surf-S110, Mirapol Surf-S210 or Mirapol Surf-S500 and mixtures thereof may above all be used according to the invention.

The copolymers prepared from a quaternary ammonium acrylamide and acrylic acid are present in the agents according to the invention preferably in a quantity of 0.1 to 5.0 wt. %, particularly preferably in a quantity of 0.2 to 2.0 wt. %, in particular in a quantity of 0.3 to 1.0 wt. %, above all in a quantity of 0.4 to 0.8 wt. %.

For the purposes of the present invention, hard surfaces in particular comprise surfaces of stone or ceramic materials, rigid plastics materials, glass or metal. Hard surfaces may be, for example, walls, work surfaces, flooring or sanitary articles. In particular, the invention relates to surfaces of ceramics, preferably ceramic sanitary ware, and very particularly of toilet bowls.

Embodiments of the present invention encompass any presentations of the agents according to the invention which are established in the prior art and/or are convenient. These include for example solid, pulverulent, liquid, gel-form or pasty agents, optionally also comprising two or more phases, compressed or uncompressed; they furthermore include extrudates, granules, tablets or pouches, packaged both in large containers and in portions.

The agent according to the invention is preferably a toilet cleaner, a bathroom cleaner or a multipurpose cleaner. When used as a toilet cleaner, the agent according to the invention preferably has a pH value of 1 to 5, in particular of 1 to 3; when used as a bathroom cleaner it preferably has a pH value of 1 to 6, in particular of 3 to 5; and when used as a multipurpose cleaner it preferably has a pH value of 8 to 12, in particular of 9 to 11.

Methods suitable for treating a surface are any conventional methods with which the agent may be applied onto the surface. For the particularly preferred case in which the agent is liquid at room temperature, the surface is preferably treated by the agent being transferred onto the surface with the assistance of an absorbent fabric or by the agent being sprayed onto the surface. However, treatment may, for example, also proceed by immersing the surface in the agent.

For the purposes of the invention, dirt or soiling should in particular be taken to mean fecal soiling and/or biofilms.

Treating a hard surface with the agent according to the invention protects it from soiling and/or facilitates the detachment of soiling from the surface and/or reduces the adhesion of microorganisms. “Reducing adhesion” should here preferably be taken to mean that at least 20, 40 or 60%, particularly preferably at least 80, 90 or 95% fewer microorganisms adhere to the hard surface than when a treatment agent without the addition of polymers to be used according to the invention is used. The percentages here relate to the difference in the total mass of the adhered material.

The microorganisms, the adhesion of which is reduced, are preferably selected from bacteria, fungi, in particular molds, viruses, in particular bacteriophages, and algae.

The bacteria, the adhesion of which is reduced, are preferably selected from the group consisting of Gram-negative and Gram-positive bacteria, above all pathogenic bacteria selected from Propionibacterium acnes, Staphylococcus aureus, Streptococcus spp., Corynebacterium spp., Micrococcus spp. (in particular M. sedentarius), Bacillus anthracia, Neisseria spp., Pseudomonas aeruginosa, P. pseudomallei, Borrelia burgdorferi, Treponema pallidum, Mycobacterium spp., Escherichia coli and Actinomyces spp., Salmonella spp., Actinobacteria (in particular Brachybacterium spp.), alpha-proteobacteria (in particular Agrobacterium spp.), beta-proteobacteria (in particular Nitrosomonas spp.), Aquabacterium spp., Hydrogenophaga, gamma-proteobacteria, Stenotrophomonas spp., Xanthomonas spp., Haemophilus spp. together with all the microorganisms described by Paster et al. (J. Bac. 183 (2001) 12, 3770-3783).

Microorganisms which are of particular relevance with regard to biofilm formation, and the adhesion of which is particularly preferably reduced, are for example aeromonads, Agrobacterium, Aquabacterium, Bradyrhizobium japonicum, Burkholderia cepacia, Chromobacterium violaceum, Dermacocci, Enterobacter agglomerans, Erwinia carotovora, Erwinia chrysanthemi, Escherichia coli, Nitrosomona europaea, Obesumbacterium proteus, Pantoea stewartii, pseudomonads, Ralstonia solanacearum, Rhizobium, Rhodobacter sphaeroides, Salmonella enterica, Serratia, Vibrio anguillarum, Vibrio fischeri, Xanthomonas, Xenorhabdus nematophilus, Yersinia, Zooshikella gangwhensis, Cythophaga sp. KT0803, Psychrobakter glacinola, Pseudoalteromonas carragenovora, Shewanella baltica and Bacillus subtilis. Some of these biofilm formers are also of relevance in the maritime sector, since they may be partly responsible for “fouling” on submerged surfaces.

In particular, without exhibiting a biocidal action, the agent preferably prevents the formation of biofilms. It is suspected that the efficacy of the agents used according to the invention against the formation of biofilms is attributable to a bacteriostatic action of the polymers used, whereby colonization of the surfaces with microorganisms is inhibited and their adhesion and multiplication on the surfaces is prevented. On the other hand, since no biocidal effects have been observed for the agents, they do not suffer from the above-mentioned disadvantages of using biocides.

The agents according to the invention bring about easier removability of soiling and a reduction in susceptibility to resoiling and in particular improve the cleaning performance of cleaning agents for hard surfaces. As a result, surfaces treated or cleaned accordingly are perceived to be clean for longer.

It has further been observed that not only easier and more rapid removal of fecal soiling but also improved rinsing away of the dried on (optionally colored) cleaning agent itself is possible if polymer mixtures according to the invention are added to the cleaning agent formulation. If fecal soiling occurs on a surface treated in this manner, the dirt can be removed without appreciable mechanical force the next time the toilet is flushed. In general, this is achieved solely by the mechanical action of the flushing water, without requiring any additional assistance from a toilet brush. If colored cleaning formulations are left to act on the surface for an extended period and the formulation dries on to some extent, the resultant colored film is nevertheless easily and completely removed the next time the toilet is flushed.

The use of polymer mixtures according to the invention as an additive in surfactant-containing cleaning agents makes it possible in a single step not only to clean a surface, but also simultaneously to provide it with protection from dirt. In this manner, lime deposition, adhesion of dirt containing protein or fat and also bacterial growth are, for example, prevented. The treated surfaces stay clean longer and subsequent cleaning is furthermore considerably facilitated. This means that, without any negative impact on cleanness, the surfaces need be cleaned less often, and subsequent cleaning thereof is associated with less effort in that it can proceed more quickly and/or requires gentler cleaning agents. In favorable cases, it is thus possible to achieve an adequate cleaning action for a certain time just with water, i.e. without requiring the use of a conventional cleaning agent.

The polymers of the polymer mixtures according to the invention may straightforwardly and simply be formulated together with the other components of the agent and may in particular also very simply be incorporated into conventional cleaning agent formulations. In particular, the advantageous solubility characteristics of these substances mean that incorporating them into conventional cleaning agents does not result in any limitations, such as for instance impaired sprayability.

In a further preferred embodiment of the invention, the agent according to the invention furthermore contains at least one hydrolyzable silicic acid derivative.

Hydrolyzable silicic acid derivatives should in particular be taken to mean the esters of orthosilicic acid, in particular tetraalkoxysilanes and very particularly preferably tetraethoxysilane. For the purposes of the present invention, hydrolyzable silicic acid derivatives should, however, also be taken to mean compounds which, in addition to three alkoxy groups, also bear a carbon residue on the silicon atom, such as for example N-(triethoxysilylpropyl)-O-polyethylene oxide urethane, dimethyloctadecyl-(3-(trimethoxysilylpropyl)-ammonium chloride, diethylphosphatoethyltriethoxysilane and the trisodium salt of N-(trimethoxysilylpropyl)ethylendiaminetriacetic acid.

The further components present in the agents according to the invention should be selected in accordance with their nature and the quantity used such that no undesired interactions occur with the polymers to be used according to the invention.

The agents according to the invention contain at least one surfactant which is selected from anionic, nonionic, amphoteric and cationic surfactants and mixtures thereof. Reference is in made to PCT patent application WO 2008/101909 with regard to surfactants which may be used according to the invention.

Anionic surfactants which are preferably suitable are C₈-C₁₈ alkylbenzene sulfonates, in particular with around 12 C atoms in the alkyl moiety, C₈-C₂₀ alkane sulfonates, C₈-C₁₈ monoalkyl sulfates, C₈-C₁₈ alkyl polyglycol ether sulfates with 2 to 6 ethylene oxide units (EO) in the ether moiety and sulfosuccinic acid mono- and di-C₈-C₁₈-alkyl esters. It is furthermore also possible to use C₈-C₁₈ α-olefin sulfonates, sulfonated C₈-C₁₈ fatty acids, in particular dodecylbenzenesulfonate, C₈-C₂₂ carboxylic acid amide ether sulfates, C₈-C₁₈ alkyl polyglycol ether carboxylates, C₈-C₁₈ N-acyl taurides, C₈-C₁₈—N-sarcosinates and C₈-C₁₈ alkyl isethionates or mixtures thereof. The anionic surfactants are preferably used as sodium salts, but may also be present as other alkali or alkaline earth metal salts, for example magnesium salts, and in the form of ammonium or mono-, di-, tri- or tetraalkylammonium salts, in the case of sulfonates, also in the form of their corresponding acid, for example dodecylbenzenesulfonic acid. Examples of such surfactants are sodium cocoalkyl sulfate, sodium sec.-alkanesulfonate with approx. 15 C atoms and sodium dioctylsulfosuccinate. Sodium fatty alkyl sulfates and fatty alkyl+2EO ether sulfates with 12 to 14 C atoms have proved particularly suitable.

Nonionic surfactants which may primarily be mentioned are C₈-C₁₈ alcohol polyglycol ethers, i.e. ethoxylated and/or propoxylated alcohols with 8 to 18 C atoms in the alkyl moiety and 2 to 15 ethylene oxide (EO) and/or propylene oxide (PO) units, C₈-C₁₈ carboxylic acid polyglycol esters with 2 to 15 EU, for example tallow fatty acid+6 EO esters, ethoxylated fatty acid amides with 12 to 18 C atoms in the fatty acid moiety and 2 to 8 EO, long-chain amine oxides with 14 to 20 C atoms and long-chain alkyl polyglycosides with 8 to 14 C atoms in the alkyl moiety and 1 to 3 glycoside units. Examples of such surfactants are oleyl-cetyl alcohol with 5 EO, nonylphenol with 10 EO, lauric acid diethanolamide, cocoalkyl dimethylamine oxide and cocoalkyl polyglucoside with on average 1.4 glucose units. C₈₋₁₈ fatty alcohol polyglycol ethers with in particular 2 to 8 EO, for example C₁₂ fatty alcohol+7-EO ether, and C₈₋₁₀ alkyl polyglucosides with 1 to 2 glycoside units are particularly preferably used.

In a preferred embodiment of the invention, the nonionic surfactant is selected from the group comprising polyalkylene oxides, in particular alkoxylated primary alcohols, the polyalkylene oxides possibly also being end group-terminated, alkoxylated fatty acid alkyl esters, amine oxides and alkyl polyglycosides and mixtures thereof.

Sitable amphoteric surfactants are for example betaines of the formula (Rⁱⁱⁱ)(R^{iv})(Rᵥ)N⁺CH₂COO⁻, in which Rⁱⁱⁱ means an alkyl residue with 8 to 25, preferably 10 to 21 carbon atoms optionally interrupted by heteroatoms or groups of heteroatoms and R^{iv} and R^{v} mean identical or different alkyl residues with 1 to 3 carbon atoms, in particular C₁₀-C₁₈ alkyl dimethyl carboxymethyl betaine and C₁₁-C₁₇ alkyl amidopropyl dimethyl carboxymethyl betaine.

Suitable cationic surfactants are inter alia the quaternary ammonium compounds of the formula (Rᵥᵢ)(Rᵥᵢᵢ)(R^{viii})(R^{ix})N⁺X⁻, in which Rᵥᵢ to R^{ix} denote four identical or different, in particular two long-chain and two short-chain, alkyl residues and X⁻ denotes an anion, in particular a halide ion, for example didecyldimethylammonium chloride, alkylbenzyldidecylammonium chloride and mixtures thereof.

In a preferred embodiment, however, the only surfactant components the agent contains are one or more anionic surfactants, preferably C₈-C₁₈ alkyl sulfates and/or C₈-C₁₈ alkyl ether sulfates, and/or one or more nonionic surfactants, preferably C₈₋₁₈ fatty alcohol polyglycol ethers with 2 to 8 EO and/or C₈₋₁₀ alkyl polyglucosides with 1 to 2 glycoside units.

In a particularly preferred embodiment of the invention, the agents according to the invention contain at least one nonionic surfactant, which is/are in particular selected from ethoxylated and/or propoxylated alcohols with 8 to 18 C atoms in the alkyl moiety and 2 to 15 ethylene oxide (EO) and/or propylene oxide (PO) units and alkyl polyglycosides with 8 to 14 C atoms in the alkyl moiety and 1 to 3 glycoside units.

The agents according to the invention preferably contain surfactants in quantities of 0.01 to 20 wt. %, in particular of 0.05 to 10 wt. %, preferably of 0.1 to 5 wt. % and particularly preferably of 0.2 to 1 wt. %, in each case relative to the total weight of the agent.

The agents according to the invention contain water and/or at least one nonaqueous solvent. Nonaqueous solvents which may preferably be considered are those solvents which are water-miscible in any desired ratio. The nonaqueous solvents include, for example, mono- or polyhydric alcohols, alkanolamines, glycol ethers and mixtures thereof. The alcohols used are in particular ethanol, isopropanol and n-propanol. Ether alcohols which may be considered are adequately water-soluble compounds with up to 10 C atoms per molecule. Examples of such ether alcohols are ethylene glycol monobutyl ether, propylene glycol monobutyl ether, diethylene glycol monobutyl ether, propylene glycol mono-tert.-butyl ether and propylene glycol monoethyl ether, among which ethylene glycol monobutyl ether and propylene glycol monobutyl ether are in turn preferred. In a preferred embodiment, however, ethanol is used as the nonaqueous solvent.

Nonaqueous solvents may be present in the agents according to the invention in quantities of 0.01 to 99.9 wt. %, in particular of 0.1 to 50 wt. %, and particularly preferably of 2 to 20 wt. %, in each case relative to the total weight of the agent.

Water is present in the agents according to the invention in quantities of 1 to 98 wt. %, in particular of 50 to 95 wt. %, and particularly preferably of 80 to 93 wt. %, in each case relative to the total weight of the agent.

In a further preferred embodiment, the agent according to the invention contains a thickener. Any viscosity regulators used in the prior art in washing and cleaning agents may in principle be considered for this purpose, such as for example organic natural thickeners (agar-agar, carrageenan, tragacanth, gum arabic, guar gum, gellan gum, xanthan gum, alginates, pectins, polyoses, guar flour, locust bean flour, starch, dextrins, gelatin, casein), modified organic natural substances (carboxymethylcellulose and other cellulose ethers, hydroxyethylcellulose and hydroxypropylcellulose and the like, seed flour ethers as well as further derivatives of polysaccharides and heteropolysaccharides), completely synthetic organic thickeners (polyacrylic and polymethacrylic compounds, vinyl polymers, polycarboxylic acids, polyethers, polyimines, polyamides) and inorganic thickeners (polysilicic acids, clay minerals such as montmorillonites, zeolites, silicas). In a preferred embodiment, the agent according to the invention contains xanthan gum and succinoglycan gum.

If the agent according to the invention contains a thickener, the latter is generally present in quantities of 0.01 to 30 wt. %, in particular of 0.2 to 15 wt. %.

Depending on the intended application, the viscosity of the agents according to the invention may be adjusted within a wide range. Accordingly, low viscosity, virtually watery formulations may be preferred for multipurpose and bathroom cleaners, while higher viscosity, thickened formulations may be preferred for other applications, for example cleaning agents. In general, the viscosity of the agents according to the invention is in the range from 1 to 3,000 mPa·s, preferably from 200 to 1,500 mPa·s and particularly preferably from 400 to 900 mPa·s (Brookfield Rotovisco LV-DV II plus viscometer, spindle 31, 20° C., 20 rpm).

In a preferred embodiment, the agent according to the invention has a pH value of less than 9, in particular a pH value of 0 to 6, preferably of 1 to 5 and particularly preferably of 2 to 4.

In a further, particularly preferred embodiment the agent according to the invention contains at least one acid. Suitable acids are in particular organic acids such as formic acid, acetic acid, citric acid, glycolic acid, lactic acid, succinic acid, adipic acid, malic acid, tartaric acid and gluconic acid or also amidosulfonic acid. It may, however, be preferred for acetic acid not to be used as the acid. The inorganic acids hydrochloric acid, sulfuric acid, phosphoric acid and nitric acid or mixtures thereof may, however, additionally be used. Particularly preferred acids are those selected from the group comprising amidosulfonic acid, citric acid, lactic acid and formic acid. They are preferably used in quantities of 0.01 to 30 wt. %, particularly preferably of 0.2 to 15 wt. %, in each case relative to the total weight of the agent.

The agents according to the invention may furthermore contain other conventional components of agents, in particular cleaning agents, for treating hard surfaces, provided that these do not interact in undesired manner with the substances used according to the invention.

Other such components which may for example be considered are further acids, salts, film formers, antimicrobial active ingredients, builders, corrosion inhibitors, complexing agents, sequestering agents, electrolytes, foam inhibitors, disintegration auxiliaries, soil-release active ingredients or soil-repellents, UV absorbers, alkalis, preservatives, bleaching agents, bleach activators, bleach catalysts, enzymes, enzyme stabilizers, abrasives, polymers together with fragrances and dyes. Overall, the agents should preferably contain no more than 30 wt. %, preferably 0.01 to 30 wt. %, in particular 0.2 to 15 wt. % of further ingredients.

The agents according to the invention may contain film formers which may assist in improving wetting of surfaces. Any film-forming polymers used in the prior art in laundry detergents and cleaning agents may in principle be considered for this purpose. Preferably, however, the film former is selected from the group comprising polyethylene glycol, polyethylene glycol derivatives and mixtures thereof, preferably with a molecular weight of between 200 and 20,000,000, particularly preferably of between 5,000 and 200,000. The film former is advantageously used in quantities of 0.01 to 30 wt. %, in particular of 0.2 to 15 wt. %.

Agents according to the invention may furthermore contain one or more antimicrobial active ingredients, preferably in a quantity of 0.01 to 1 wt. %, in particular of 0.05 to 0.5 wt. %, particularly preferably of 0.1 to 0.3 wt. %. Suitable antimicrobial active ingredients are for example those from the groups of alcohols, aldehydes, antimicrobial acids or the salts thereof, carboxylic acid esters, acid amides, phenols, phenol derivatives, diphenyls, diphenyl alkanes, urea derivatives, oxygen or nitrogen acetals and formals, benzamidines, isothiazoles and the derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophores and peroxides. It is furthermore also possible to use antimicrobially active essential oils which simultaneously fragrance the cleaning agent.

Water-soluble and/or water-insoluble builders may be used in the agents according to the invention. Water-soluble builders are here preferred as they generally have a lesser tendency to leave insoluble residues behind on hard surfaces. Conventional builders which may be present for the purposes of the invention are low molecular weight polycarboxylic acids and the salts thereof, homopolyrneric and copolymeric polycarboxylic acids and the salts thereof, citric acid and the salts thereof, carbonates, phosphates and silicates. Water-insoluble builders include zeolites, which may likewise be used, together with mixtures of the above-stated builder substances. Reference is made to published patent application WO 2008/101909 with regard to further builders and/or cobuilders usable according to the invention and the preferred quantities thereof to be used.

Suitable corrosion inhibitors are for example the following substances listed by their INCI names: Cyclohexylamine, Diammonium Phosphate, Dilithium Oxalate, Dimethylamino Methylpropanol, Dipotassium Oxalate, Dipotassium Phosphate, Disodium Phosphate, Disodium Pyrophosphate, Disodium Tetrapropenyl Succinate, Hexoxyethyl Diethylammonium, Phosphate, Nitromethane, Potassium Silicate, Sodium Aluminate, Sodium Hexametaphosphate, Sodium Metasilicate, Sodium Molybdate, Sodium Nitrite, Sodium Oxalate, Sodium Silicate, Stearamidopropyl Dimethicone, Tetrapotassium Pyrophosphate, Tetrasodium Pyrophosphate, Triisopropanolamine. Reference is made to published patent application WO 2008/101909 with regard to further corrosion inhibitors, in particular also glass corrosion inhibitors, usable according to the invention.

Complexing agents, which are also known as sequestrants, are ingredients which are capable of complexing and inactivating metal ions in order to prevent their disadvantageous effects on the stability or appearance, for example cloudiness, of the agents. On the one hand, it is important to complex the calcium and magnesium ions of water hardness which are incompatible with numerous ingredients. On the other hand, complexation of heavy metal ions such as iron or copper delays oxidative decomposition of the finished agents. Complexing agents additionally support the cleaning action. The following complexing agents, listed by their INCI names, are for example suitable: Aminotrimethylene, Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Agents according to the invention may furthermore contain alkalis. The bases used in agents according to the invention are preferably those from the group of alkali metal and alkaline earth metal hydroxides and carbonates, in particular sodium carbonate or sodium hydroxide. It is, however, also possible additionally to use ammonia and/or alkanolamines with up to 9 C atoms per molecule, preferably ethanolamines, in particular monoethanolamine.

Agents according to the invention may likewise contain preservatives. The substances stated in relation to the antimicrobial active ingredients may essentially be used for this purpose.

According to the invention, the agents may furthermore contain bleaching agents. Suitable bleaching agents comprise peroxides, peracids and/or perborates; hydrogen peroxide is particularly preferred. Sodium hypochlorite, on the other hand, is less suitable in cleaning agents with an acidic formulation due to the release of toxic chlorine gas vapors, but may be used in alkaline cleaning agents. Under certain circumstances, a bleach activator may be present in addition to the bleaching agent. Reference is made to published patent application WO 2008/101909 with regard to further bleaching agents usable according to the invention and with regard to bleach activators and bleach catalysts usable according to the invention and with regard to the preferred quantities thereof to be used.

The agent according to the invention may also contain enzymes, preferably proteases, lipases, amylases, hydrolases and/or cellulases. They may be added to the agent in any form established in the prior art. In the case of agents in liquid or gel form, this in particular includes solutions of the enzymes, advantageously as concentrated as possible, with a low water content and/or combined with stabilizers. Alternatively, the enzymes may be encapsulated, for example by spray drying or extruding the enzyme solution together with a preferably natural polymer or in the form of capsules, for example those in which the enzymes are enclosed as a solidified gel or in those of the core-shell type, in which an enzyme-containing core is coated with a protective layer which is impermeable to water, air and/or chemicals. Further active ingredients, for example stabilizers, emulsifiers, pigments, bleaching agents or dyes may additionally be applied in superimposed layers. Such capsules are applied in accordance with per se known methods, for example by agitated or rolling granulation or in fluidized bed processes. Advantageously, such granules are low-dusting, for example due to the application of polymeric film formers, and stable in storage thanks to the coating.

Agents containing enzymes may furthermore contain enzyme stabilizers in order to protect an enzyme present in an agent according to the invention from damage, such as for example inactivation, denaturation or disintegration, for instance due to physical influences, oxidation or proteolytic cleavage. Depending in each case on the enzyme used, suitable enzyme stabilizers are in particular: benzamidine hydrochloride, borax, boric acids, boronic acids or the salts or esters thereof, above all derivatives with aromatic groups, for instance substituted phenylboronic acids or the salts or esters thereof; peptide aldehydes (oligopeptides with a reduced C terminus), aminoalcohols such as mono-, di-, triethanol- and -propanolamine and mixtures thereof, aliphatic carboxylic acids up to C12, such as succinic acid, other dicarboxylic acids or salts of the stated acids; end group-terminated fatty acid amide alkoxylates; lower aliphatic alcohols and especially polyols, for example glycerol, ethylene glycol, propylene glycol or sorbitol; and reducing agents and antioxidants such as sodium sulfite and reducing sugars. Further suitable stabilizers are known from the prior art. Combinations of stabilizers are preferably used, for example the combination of polyols, boric acid and/or borax, the combination of boric acid or borate, reducing salts and succinic acid or other dicarboxylic acids or the combination of boric acid or borate with polyols or polyamino compounds and with reducing salts.

Reference is made to PCT patent application WO 2008/101909 with regard to further enzymes and enzyme stabilizers which are usable according to the invention and the preferred quantities thereof to be used.

The agent according to the invention may finally contain one or more fragrances and/or one or more dyes as further ingredients. Dyes which may be used are both water-soluble and oil-soluble dyes, it being necessary on the one hand to ensure compatibility with further constituents, for example bleaching agents, and, on the other hand, that the dye used should not have a substantive action towards the surfaces, in particular towards toilet ceramics, even in the event of an extended period of action. Selection of a suitable scent is likewise limited only by possible interactions with the other components of the cleaning agent.

Reference is made to PCT patent application WO 2008/101909 with regard to sequestering agents, electrolytes, foam inhibitors, disintegration auxiliaries, “soil-release” active ingredients or “soil-repellents” and UV absorbers which are preferably usable according to the invention, and with regard to the preferred quantities thereof to be used.

A cleaning product for hard surfaces according to the invention may also contain one or more propellants (INCI Propellants), conventionally in a quantity of 1 to 80 wt. %, preferably of 1.5 to 30 wt. %, in particular of 2 to 10 wt. %, particularly preferably of 2.5 to 8 wt. %, extremely preferably of 3 to 6 wt. %.

Reference is made to PCT patent application WO 2008/101909 with regard to propellants which are preferably usable according to the invention.

The present invention also provides a product containing a cleaning product for hard surfaces according to the invention and a spray dispenser. The product may here be both a single chamber and a multichamber container, in particular a two-chamber container. The spray dispenser is here preferably a manually actuated spray dispenser, in particular selected from the group encompassing aerosol spray dispensers (pressurized gas container; also inter alia known as a spray can), self-pressurizing spray dispensers, pump spray dispensers and trigger spray dispensers, in particular pump spray dispensers and trigger spray dispensers with a container made from transparent polyethylene or polyethylene terephthalate. Spray dispensers are described in greater detail in WO 96/04940 (Procter & Gamble) and the US patents cited therein in relation to spray dispensers, to which full reference is made in this respect and the content of which is hereby incorporated into the present application. Trigger spray dispensers and pump atomizers have the advantage over pressurized gas containers that no propellant need be used. Suitable attachments, nozzles etc. (“nozzle-valves”) on the spray dispenser through which particles can pass mean that an optionally present enzyme may in this embodiment optionally also be added to the agent in a form immobilized on particles and accordingly be dispensed as a cleaning foam.

The agent according to the invention is preferably a cleaning agent, in particular a cleaning agent for ceramics, particularly preferably for ceramic sanitary ware.

The agent according to the invention may be produced in a manner conventional in the art by suitably mixing the components present in the agent with one another.

The present invention accordingly also provides a method for producing an agent according to the invention, in which the individual components are mixed with one another.

The present invention also provides a method for treating a hard surface, in which the surface is brought into contact with an agent according to the invention, as described in the preceding text.

This method may be carried out as an independent treatment method for the surface, for example in order to provide it with dirt-repellent properties or one or more of the other properties brought about by the agents according to the invention in accordance with the teaching of the present invention. The surface is here brought into contact with an agent according to the invention.

The method according to the invention is preferably carried out in such a manner that the agent is distributed over the surface and advantageously then either rinsed off after a period of action of 1 second to 20 minutes, preferably of 1 to 10 minutes, or alternatively left to dry.

In a preferred embodiment of the method, contacting proceeds at a temperature of 5 to 50° C., in particular of 15 to 35° C.

In a particularly preferred embodiment, the method according to the invention is a cleaning method which serves for surface cleaning.

In particular, the method according to the invention serves for treating a surface of ceramics, glass, stainless steel or plastics material.

Another embodiment of the invention relates to the use of an agent according to the invention for protecting a hard surface from soiling and/or for easier detachment of renewed soiling from the surface, the soiling in particular involving fecal soiling and/or biofilms and/or protein deposits.

In a preferred embodiment of the invention, agents according to the invention serve for the improved removal of fecal soiling and/or biofilms from the surfaces of flush toilets and/or for reducing renewed soiling of such surfaces with fecal soiling and/or biofilms. To this end, the agent is advantageously distributed over the surface and either rinsed off after a period of action of preferably 1 to 10 minutes or alternatively left to dry. Once the surface has been treated in this manner, fecal soiling is easier to remove, often without the assistance of mechanical aids, such as for instance a toilet brush. Any dried on cleaning agent residues may additionally be rinsed away more easily.

Another embodiment of the invention relates to the use of an agent according to the invention for providing a water-repellent finish on a hard surface and/or for shortening the drying time of a hard surface after exposure to water.

For cleaning reasons, it is on the one hand more favorable for surfaces to comprise hydrophilic properties, since such surfaces can readily be wetted with conventional water-based cleaning fluids, so facilitating washing processes. On the other hand, it is also desired for the surfaces, once they have been cleaned with water or with water-based cleaning agents, to be free of the film of water again as quickly as possible, i.e. for the water to drain away as quickly and completely as possible, so that no film of water remains on the surface. Otherwise, when the film of water dries out, residual soiling may remain on the surface, such as for example lime deposit, which looks unattractive and may promote renewed soiling, for example also due to proteins and microorganisms. For this reason, it is highly advantageous that treating a surface with the agents according to the invention renders this surface hydrophilic. These facilitates wetting and detachment of dirt and simultaneously ensures that the surface is readily “dewetted” of a film of water, so avoiding water drops being formed and residual soiling being left behind. This property is particularly beneficial where surfaces are particularly exposed to lime and dirt and biofilm deposits, such as typically toilet bowls, washbasins, bathtubs and shower cubicles. Another advantage of this property is that water drains away faster from treated surfaces and these consequently dry more quickly. In a cleaning process, rinsing with clean water is generally required after treating the surface with cleaning product. It is desirable for the surfaces to dry quickly after this rinsing, for example because a quickly drying surface enhances the consumer's impression of cleanliness.

The present invention also provides the use of an agent according to the invention for providing a bacteriostatic finish on a hard surface.

One particular advantage of the polymer mixtures used according to the invention is that colonization by and the growth of microorganisms is suppressed on surfaces treated therewith, without biocides being required for this purpose. In this manner, a surface finish is obtained on which bacterial multiplication is prevented or substantially delayed. This is a distinct advantage relative to the prior art, in particular in the light of the fact that the use of biocides is regarded increasingly more critically with regard to environmental and consumer protection.

Another embodiment of the invention accordingly relates to the use of polymer mixtures according to the invention for providing a bacteriostatic finish on a hard surface.

Bathroom cleaners which are particularly preferred according to the invention comprise:

(a) 0.5 to 12 wt. %, preferably 1 to 10 wt. % and in particular 2 to 8 wt. % of an organic acid and/or of a salt of organic acids preferably selected from formic acid, citric acid, lactic acid and mixtures thereof and salts of these organic acids;
(b) 0.1 to 5 wt. %, preferably 0.2 to 4 wt. % and in particular 0.5 to 3 wt. % of surfactant(s), preferably nonionic and/or anionic surfactant(s), particularly preferably nonionic surfactant(s), in particular alkyl polyglycoside(s);
(c) 0.1 to 5 wt. %, preferably 0.2 to 4 wt. % and in particular 0.5 to 3 wt. % of thickeners; and
(d) 0.01 to 5 wt. %, preferably 0.02 to 4 wt. % and in particular 0.05 to 3 wt. % of at least two polymers selected from the group consisting of a multi-armed polyalkoxylate, in particular silyl polyalkoxylate, a polyesteramide and a copolymer prepared from a quaternary ammonium acrylamide and acrylic acid;
wherein the cleaners have a pH value of 1 to 6, preferably of 3 to 5.

Toilet cleaners which are particularly preferred according to the invention comprise:

(a) 0.5 to 12 wt. %, preferably 1 to 10 wt.% and in particular 2 to 8 wt. % of an organic acid and/or of a salt of organic acids preferably selected from formic acid, citric acid, lactic acid and mixtures thereof and salts of these organic acids;
(b) 0.1 to 5 wt. %, preferably 0.2 to 4 wt. % and in particular 0.5 to 3 wt. % of surfactant(s), preferably nonionic and/or anionic surfactant(s), particularly preferably nonionic surfactant(s), in particular alkyl polyglycoside(s);
(c) 0.1 to 5 wt. %, preferably 0.2 to 4 wt. % and in particular 0.5 to 3 wt. % of thickeners; and
(d) 0.01 to 5 wt. %, preferably 0.02 to 4 wt. % and in particular 0.05 to 3 wt. % of at least two polymers selected from the group consisting of a multi-armed polyalkoxylate, in particular silyl polyalkoxylate, a polyesteramide and a copolymer prepared from a quaternary ammonium acrylamide and acrylic acid;
wherein the cleaners have a pH value of 1 to 5, preferably of 1 to 3.

Multipurpose cleaners which are particularly preferred according to the invention comprise:

(a) 0.05 to 5 wt. %, preferably 0.1 to 2 wt. % and in particular 0.2 to 1 wt. % of an organic acid and/or of a salt of organic acids, preferably selected from formic acid, citric acid, lactic acid and mixtures thereof and salts of these organic acids;
(b) 0.1 to 8 wt. %, preferably 0.2 to 6 wt. % and in particular 0.5 to 5 wt. % surfactant(s), preferably nonionic and/or anionic surfactant(s), particularly preferably sulfate(s), sulfonate(s), fatty alcohol ethoxylate(s), alkyl polyglycoside(s) or mixtures thereof;
(c) 0.1 to 8 wt. %, preferably 0.5 to 6 wt. % and in particular 1 to 5 wt. % of fatty acid(s), in particular of C₁₂₋₁₈ fatty acid(s), and/or of a salt thereof; 0.1 to 6 wt. %, preferably 0.2 to 5 wt. % and in particular 0.5 to 4 wt. % of an organic solvent, in particular ethanol; and
(d) 0.01 to 5 wt. %, preferably 0.02 to 4 wt. % and in particular 0.05 to 3 wt. % of at least two polymers selected from the group consisting of a multi-armed polyalkoxylate, in particular silyl polyalkoxylate, a polyesteramide and a copolymer prepared from a quaternary ammonium acrylamide and acrylic acid;
wherein the cleaners have a pH value of 8 to 12, preferably of 9 to 11.

### EXEMPLARY EMBODIMENTS

### Example 1

### Synthesis of Multi-Armed Silyl Polyalkoxylates

(a) Production of a Hexa-Armed Triethoxysilyl-Terminated Polyalkoxylate

The starting material used was polyether polyol which is a hexa-armed random poly(ethylene oxide-co-propylene oxide) with an EO:PO ratio of 80:20 and with a molecular weight of 12,000 g/mol and was produced by anionic ring-opening polymerization of ethylene oxide and propylene oxide using sorbitol as initiator. Before being further reacted, the polyether polyol was heated to 80° C. for 1 h under a vacuum with stirring. A solution of polyether polyol (3 g, 0.25 mmol), triethylenediamine (9 mg, 0.081 mmol) and dibutyltin dilaurate (9 mg, 0.014 mmol) in 25 ml of anhydrous toluene was initially introduced and a solution of (3-isocyanatopropyl)triethoxysilane (0.6 ml, 2.30 mmol) in 10 ml of anhydrous toluene was added dropwise thereto. Stirring of the solution at 50° C. was continued overnight. After removal of the toluene under a vacuum, the crude product was repeatedly washed with anhydrous ether. After vacuum drying, the product, comprising in each case a triethoxylsilyl group at the free ends of the polymer arms of the stellate prepolymer, was obtained as a colorless viscous liquid. IR (film, cm⁻¹): 3349 (m, —CO—NH—), 2868 (s, —CH₂—, —CH₃), 1719 (s, —C═O), 1456 (m, —CH₂—, —CH₃), 1107 (s, —C—O—C—), 954 (m, —Si—O—). ¹H-NMR (benzene d₆, ppm): 1.13 (d, —CH₃ from polymer arms), 1.21 (t, —CH₃ from silane end groups), 3.47 (s, —CH₂ from polymer arms), 3.74 (q, —CH₂ from silane end groups). The resultant triethoxysilyl-terminated polyalkoxylate has a molecular weight of 13,500.

(b) Production of a Tri-Armed Triethoxysilyl-Terminated Polyalkoxylate

Voranol CP 1421 from DOW Chemicals was dried for 1 h at 80° C. under a vacuum with stirring. 317 mg (1.0 equivalent) of (3-isocyanatopropyl)triethoxysilane were slowly added to 2.04 g (0.41 mmol) of the dried polyether polyol. The reaction mixture was stirred under protective gas at 100° C. for a further 2 days, until the NCO group vibration band on IR measurement had disappeared. The product, comprising in each case a triethoxylsilyl group at the free ends of the polymer arms of the polyether polyol, was obtained as a colorless viscous liquid.

(c) Production of a Mixture Containing a Tri-Armed and an Octa-Armed Triethoxysilyl-Terminated Polyalkoxylate.

Voranol 4053 from DOW Chemicals was dried for 1 h at 80° C. under a vacuum with stirring. 20.9 mg (0.01%) of dibutyltin dilaurate and 30.3 g (1.0 equivalent) of (3-isocyanatopropyl)triethoxysilane were slowly added to 209 g (16.9 mmol) of the dried polyether polyol. As an alternative to dibutyltin dilaurate, DABCO (1,4-diazabicyclo[2.2.2]octane) may for instance also be used as catalyst. The reaction mixture was stirred under protective gas at room temperature for a further 2 days, until the NCO band on IR measurement had disappeared. The product, comprising in each case a triethoxylsilyl group at the free ends of the polymer arms of the polyether polyol and constituting a mixture of a tri-armed and an octa-aimed polyalkoxylate in a ratio of approx. 20:80, was obtained as a colorless viscous liquid (Hydrostellan S100).

### Example 2

### Toilet Reactor Test with Individual Polymers and Polymer Mixtures

The preventive action of various polymers with regard to biofilm reduction as a function of their concentration in a conventional commercial toilet cleaner was investigated in a realistic, dynamic system. The preventive action of the individual polymers was additionally compared with the action of mixtures of these polymers.

The “toilet reactor” replicates the flushing cycles of a toilet and thus the periodic wetting and drying of ceramic surfaces.

This system makes it possible to investigate adhesion and biofilm formation in a test system on several different surfaces over a defined period of 48 h. Instead of the water used in a real toilet, it is fresh medium (TBY 1:50) which is passed over the glazed tiles.

The reactor is initially filled with 680 ml of medium and inoculated with a microbial mixture consisting of Dermacoccus nishinomiyaensis DSMZ 20448, Bradyrhizobium japonicum DSMZ 1982 and Xanthomonas campestris DSMZ 1526, which forms a stable biofilm in aqueous environments. Incubation proceeds overnight, so that the microbial flora can get established in the system.

“Water flushing” proceeds under semi-automatic control by a pump and the time-delayed opening of a solenoid valve. 680 ml of medium are used per flush. On each of the first and second days after incubation, flushing is performed 15 times, an individual flush cycle lasting for 20 minutes.

After a total of 30 flushes, the glazed tiles are removed at the end of the reactor run.

Before being clamped in the reactor, the horizontally placed glazed tiles were immersed for three minutes in 15-20 ml of the polymer solution at defined concentrations, then briefly rinsed with water and dried for two hours at 60° C. A cleaning product formulation was used as solvent.

After removal from the reactor, the glazed ceramic tiles were dried at room temperature and then each stained with 6 ml of 0.01% Safranin O solution for 15 minutes. The stain solution is then drawn off, any unbound stain is removed from the tiles with twice-distilled H₂O and the stained glazed tiles are dried. The stained surfaces are scanned and evaluated with Corel Draw Paint 9. The background value (caused by the ceramic) is measured on untreated surfaces and deducted from the detected color intensity of the stained glazed tiles. The intensity of the biofilm on glazed tiles which were treated at the outset solely with the cleaning product without added polymer is set as the reference value for 100% biofilm formation or 0% biofilm reduction.

TABLE 1
Reducing action of individual polymers and polymer
combinations formulated in a toilet cleaner

| | Conc. | Biofilm |
|---|---|---|
| Polymer(s) | [wt. %] | reduction [%] |
| Copolymer of diallyldimethylammonium | 0.5 | 25 ± 7 |
| acrylamide and acrylic acid | | |
| DSM Hybrane DAEO 5000 | 0.1 | 35 ± 7 |
| | 0.5 | 36 ± 2 |
| | 1.0 | 49 ± 4 |
| | 1.5 | 61 ± 8 |
| | 2.0 | 67 ± 12 |
| Hydrostellan S100 | 0.01 | 14 ± 5 |
| | 0.05 | 42 ± 6 |
| | 0.1 | 53 ± 9 |
| | 0.25 | 71 ± 4 |
| | 0.5 | 43 ± 2 |
| | 1.0 | 14 ± 14 |
| Copolymer of diallyldimethylammonium | 0.5 | 58 ± 7 |
| acrylamide and acrylic acid + | 0.1 | |
| DSM Hybrane DAEO 5000 | | |
| DSM Hybrane DAEO 5000 + | 0.1 | 69 ± 1 |
| Hydrostellan S100 | 0.05 | |
| Control (without polymer) | 0 | 0 |

The values stated in wt. % relate in each case to the quantity of active substance present.

DSM Hybrane DAEO 5000 is a branched polyesteramide which contains quaternized ammonium groups and long-chain polyoxyethylene groups.

It was surprisingly found that combinations of the polymers exhibit a distinctly greater preventive action relative to biofilm formation than the individual polymers used in the same quantity. It is therefore to be assumed that a synergistic effect is at play. When using polymer mixtures, the same overall effect may thus be achieved with a relatively small total quantity of polymers.

### Example 3

### Verification of the Biocidal Properties of the Polymers

The biocidal properties of the individual polymers were investigated to standard DIN-EN 1276 on Staphylococcus aureus, Enterococcus hirae, Pseudomonas aeruginosa and Escherichia coli.

The biocidal properties were then compared with the biorepulsive properties of the polymers, which were determined as described in Example 2.

Glazed tiles, which were treated at the outset with water, were used as the reference in order to ascertain biofilm reduction by the toilet cleaner itself.

With regard to biorepulsive efficacy, the toilet cleaner with addition of the polymers Hydrostellan, DSM Hybrane Quat or DSM Hybrane 5000 in each case exhibited an approx. 70% increase in biofilm reduction. The biocidal action of the various cleaning product formulations, on the other hand, was very largely maintained. Both the 80% cleaning product/polymer formulations under ‘clean’ and ‘dirty’ conditions, and the 10% formulations under ‘clean’ conditions, exhibited the same biocidal action as the toilet cleaner without polymer.

TABLE 2
Comparison of the biocidal (EN1276) and biorepulsive efficacy
(biofilm reduction) of various polymers formulated in WC-Jumbo
toilet cleaner

| | EN1276 | | | Biofilm |
|---|---|---|---|---|
| | Concentration | 80% | | reduction |
| | Test condition | clean | dirty | [%] |
| Toilet cleaner + | S. aureus | 2.97E+05 | 2.97E+05 | 71 ± 5 |
| 0.25 wt. % Hydrostellan | E. hirae | 1.32E+05 | 1.32E+05 | |
| | P. aeruginosa | 2.73E+05 | 2.73E+05 | |
| | E. coli | 1.73E+05 | 1.73E+05 | |
| Toilet cleaner + 1 wt. % | S. aureus | 2.97E+05 | 2.97E+05 | 66 ± 7 |
| active substance DSM | E. hirae | 1.32E+05 | 1.32E+05 | |
| Hybrane DAEO Quat | P. aeruginosa | 2.73E+05 | 2.73E+05 | |
| | E. coli | 1.73E+05 | 1.73E+05 | |
| Toilet cleaner + 1 wt. % | S. aureus | 2.97E+05 | 2.97E+05 | 68 ± 4 |
| active substance DSM | E. hirae | 1.32E+05 | 1.32E+05 | |
| Hybrane DAEO 5000 | P. aeruginosa | 2.73E+05 | 2.73E+05 | |
| | E. coli | 1.73E+05 | 1.73E+05 | |
| Toilet cleaner (control) | S. aureus | 2.97E+05 | 2.97E+05 | −6 ± 1 |
| | E. hirae | 1.32E+05 | 1.32E+05 | |
| | P. aeruginosa | 2.73E+05 | 2.73E+05 | |
| | E. coli | 1.73E+05 | 1.73E+05 | |

### Example 4

### Formulations

(a) Toilet Cleaner Formulations

| Component | | | | | |
|---|---|---|---|---|---|
| C9/11-8EO (Neodol 91/8E) | 1.5 | 1.5 | 1.5 | 1.5 | 1.5 |
| Formic acid | 5.0 | 5.0 | 5.0 | 5.0 | 5.0 |
| Xanthan thickener | 0.35 | 0.35 | 0.35 | 0.35 | 0.35 |
| (Kelzan ASX-T) | | | | | |
| Perfume | 0.25 | 0.25 | 0.25 | 0.25 | 0.25 |
| NaOH | 0.15 | 0.15 | 0.15 | 0.15 | 0.15 |
| Copolymer of | 0.5 | | 0.5 | 0.5 | 0.3 |
| diallyldimethylammonium | | | | | |
| acrylamide and acrylic acid | | | | | |
| DSM Hybrane 5000 | 0.1 | 0.1 | — | 0.1 | 0.05 |
| Hydrostellan S100 | — | 0.05 | 0.05 | 0.05 | 0.05 |
| Dyes | + | + | + | + | + |
| Water | Ad 100 | Ad 100 | Ad 100 | Ad 100 | Ad 100 |

The values in the table are stated in wt. % active substance relative to the total composition. The pH value of the compositions was adjusted to 2.2. The viscosity of the compositions at 20° C. was 550 mPa·s (Brookfield LV-DV II+, spindle 31, 20 rpm).

(b) Bathroom Cleaner Formulations

| Component | | | | | |
|---|---|---|---|---|---|
| C8/10 Alkyl polyglucoside | 1.5 | 1.5 | 1.5 | 1.5 | 1.5 |
| (Glucopon 215 UP) | | | | | |
| Citric acid 1-hydrate | 3.5 | 3.5 | 3.5 | 3.5 | 3.5 |
| Perfume | 0.1 | 0.1 | 0.1 | 0.1 | 0.1 |
| NaOH | 0.8 | 0.8 | 0.8 | 0.8 | 0.8 |
| Copolymer of | 0.5 | | 0.5 | 0.5 | 0.3 |
| diallyldimethylammonium | | | | | |
| acrylamide and acrylic acid | | | | | |
| DSM Hybrane 5000 | 0.1 | 0.1 | — | 0.1 | 0.05 |
| Hydrostellan S100 | — | 0.05 | 0.05 | 0.05 | 0.05 |
| Preservatives | + | + | + | + | + |
| Dyes | + | + | + | + | + |
| Water | Ad 100 | Ad 100 | Ad 100 | Ad 100 | Ad 100 |

The values in the table are stated in wt. % active substance relative to the total composition. The pH value of the compositions was adjusted to 3.9. The viscosity of the compositions at 20° C. was less than 10 mPa·s (Brookfield LV-DV II+, spindle 31, 20 rpm).

(c) Multipurpose Cleaners

| Component | | | | | |
|---|---|---|---|---|---|
| C10/13 | 2.5 | 2.5 | 2.5 | 2.5 | 2.5 |
| Alkylbenzenesulfonic acid, | | | | | |
| sodium salt (Maranil A55) | | | | | |
| C12/18 Fatty acid sodium | 4.0 | 4.0 | 4.0 | 4.0 | 4.0 |
| salt | | | | | |
| C12/18-7EO | 1.5 | 1.5 | 1.5 | 1.5 | 1.5 |
| (Dehydol LT7) | | | | | |
| Trisodium citrate 2-hydrate | 0.4 | 0.4 | 0.4 | 0.4 | 0.4 |
| Ethanol | 2.0 | 2.0 | 2.0 | 2.0 | 2.0 |
| Perfume | 0.8 | 0.8 | 0.8 | 0.8 | 0.8 |
| Copolymer of | 0.5 | | 0.5 | 0.5 | 0.3 |
| diallyldimethylammonium | | | | | |
| acrylamide and acrylic acid | | | | | |
| DSM Hybrane 5000 | 0.1 | 0.1 | — | 0.1 | 0.05 |
| Hydrostellan S100 | — | 0.05 | 0.05 | 0.05 | 0.05 |
| Preservatives | + | + | + | + | — |
| Dyes | + | + | + | + | + |
| Water | Ad 100 | Ad 100 | Ad 100 | Ad 100 | Ad 100 |

The values in the table are stated in wt. % active substance relative to the total composition. The pH value of the compositions was adjusted to 10.0.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. An agent for treating a hard surface comprising a mixture of at least two components selected from the group consisting of (a) a multi-armed stellate polyalkoxylate; (b) a polyesteramide; and (c) a copolymer prepared from a quaternary ammonium acrylamide and acrylic acid.

2. The agent according to claim 1, wherein said multi-armed stellate polyalkoxylate is a silyl polyalkoxylate having the general formula (I):
(H-D)ₚ-Z-[D-E-Si(OR¹)ᵣ(R²)₃₋ᵣ]ₒ (I),
wherein
Z is an (o+p)-valent residue with at least three carbon atoms, in which o+p has a sum of 3 to 100;
D is a divalent polyoxyalkylene residue, in which the D residues attached to Z may differ from one another, and in which one residue D is in each case joined to Z via an oxygen atom belonging to Z, and an oxygen atom belonging to D is joined to E or hydrogen;
E denotes a chemical bond or a divalent organic residue with 1 to 50 carbon atoms;
OR¹ denotes a hydrolyzable group;
R¹ and R² mutually independently mean a linear or branched alkyl group with 1 to 6 carbon atoms;
r denotes an integer from 1 to 3;
o denotes 0 or an integer ≧1; and
p denotes 0 or an integer ≧1.

3. The agent according to claim 2, wherein D is:
—(CHR³—CHR⁴—O)_{q}—
wherein R³ and R⁴ are independently chosen from hydrogen, methyl, or ethyl; and
q is an integer from 2 to 10,000.

4. The agent according to claim 2, wherein E is a covalent bond between D and silicon.

5. The agent according to claim 2, wherein E is —C(O)—NH—(CH₂)₃—.

6. The agent according to claim 2, wherein o is 0, 1, or 2, and p is 3, 4, 5, 6, 7, or 8.

7. The agent according to claim 1, wherein said polyesteramide comprises at least two groups having the formula (II): 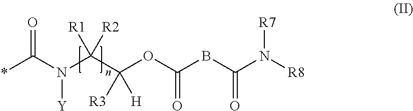
wherein Y denotes H, C₁₋₂₀ alkyl or cycloalkyl, C₆₋₁₀ aryl, or 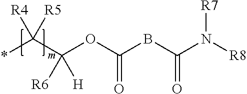
wherein B denotes C₂₋₂₄ alkylene or C₆₋₂₄ arylene; R1, R2, R3, R4, R5 and R6 mutually independently denote H, C₁₋₈ alkyl or cycloalkyl or C₆₋₁₀ aryl; R7 and R8 mutually independently denote C₁₋₂₈ alkyl or C₆₋₁₀ aryl optionally substituted by heteroatoms; and m and n mutually independently assume a value from 1 to 4.

8. The agent according to claim 7, wherein R7 and R8 are mutually independently mono- or polysubstituted by groups selected from alcohols, ethers, polyethers, esters, cyanide, carbonate, urethane, urea, amide, imide, amine, imine, imidazole, oxime, sulfide, thiol, thiourea, sulfone, sulfone oxide, sulfate, phosphate, phosphine, phosphine oxide, silane, silicone, silicate, fluorine, chlorine, bromine, or iodine, and from groups which contain at least one of the above-stated functional groups.

9. The agent according to claim 1, wherein said polyesteramide comprises at least two groups having the formula (III): 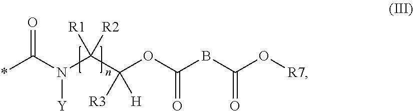
wherein Y denotes H, C₁₋₂₀ alkyl or cycloalkyl, C₆₋₁₀ aryl, or 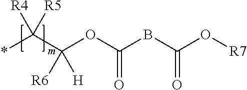
wherein B denotes C₂₋₂₄ alkylene or C₆₋₂₄ arylene; R1, R2, R3, R4, R5 and R6 mutually independently denote H, C₁₋₈ alkyl or cycloalkyl or C₆₋₁₀ aryl; R7 denotes C₁₋₂₈ alkyl or C₆₋₁₀ aryl optionally substituted by heteroatoms; and m and n mutually independently assume a value from 1 to 4.

10. The agent according to claim 1, wherein said polyesteramide is a polymer having the formula (IV): 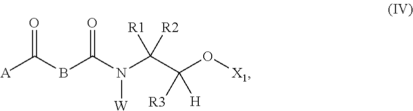
wherein W denotes H, C₁₋₂₀ alkyl, C₆₋₁₀ aryl or 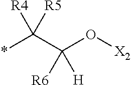
A denotes OH or 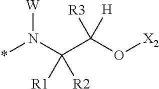
B denotes C₂₋₂₄ alkylene or C₆₋₂₄ arylene;
X₁ denotes 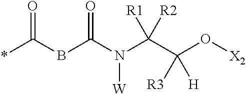
X₂ denotes H, X₁, 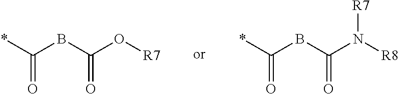
R1, R2, R3, R4, R5 and R6 mutually independently denote H, C₁₋₈ alkyl, C₆₋₁₀ aryl or —CH₂—OX₂; and R7 and R8 mutually independently denote C₁₋₂₈ alkyl or C₆₋₁₀ aryl optionally substituted by heteroatoms.

11. The agent according to claim 1, wherein said polyesteramide is a polymer having the formula (V): 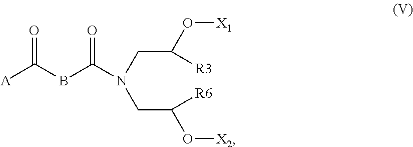
wherein A denotes OH or 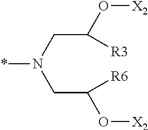
B denotes C₂₋₂₄ alkylene or C₆₋₂₄ arylene;
X₁ denotes 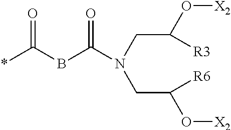
X₂ denotes hydrogen, X₁, 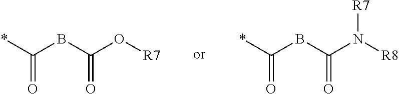
R3 and R6 mutually independently denote H, C₁₋₈ alkyl or C₆₋₁₀ aryl; and R7 and R8 mutually independently denote C₁₋₂₈ alkyl or C₆₋₁₀ aryl optionally substituted by heteroatoms or by groups containing heteroatoms.

12. The agent according to claim 11, wherein R7 and R8 are mutually independently mono- or polysubstituted by groups selected from alcohols, ethers, polyethers, esters, cyanide, carbonate, urethane, urea, amide, imide, amine, imine, imidazole, oxime, sulfide, thiol, thiourea, sulfone, sulfone oxide, sulfate, phosphate, phosphine, phosphine oxide, silane, silicone, silicate, fluorine, chlorine, bromine, or iodine, and from groups which contain at least one of the above-stated functional groups.

13. The agent according to claim 1, wherein said copolymer is a diallyldimethylammonium acrylamide.

14. The agent according to claim 1, further comprising at least one surfactant.

15. The agent according to claim 1, wherein the pH of said agent is less than 9.

16. The agent according to claim 1, wherein the pH of said agent is 2-4.

17. A method for treating a hard surface, said method comprising the steps of:
a. bringing the agent of claim 1 into contact with said surface;
b. spreading said agent extensively over said surface; and
c. optionally rinsing off said agent from said surface after a dwell time of from 1 second to 20 minutes.

18. The method according to claim 17, wherein said hard surface is ceramic, glass, stainless steel or plastic.
